(19) United States
(12) Patent Application Publication
(10) Pub. No.: US 2025/0068991 A1
(43) Pub. Date: Feb. 27, 2025

(54) ALLOCATING METHOD AND DEVICE OF CARBON EMISSION ALLOWANCE AND COMPUTER-READABLE STORAGE MEDIUM

(71) Applicant: JIANGSU XCMG CONSTRUCTION MACHINERY RESEARCH INSTITUTE LTD., Xuzhou (CN)

(72) Inventors: Pengfei CHEN, XUZHOU (CN); Guangcun WANG, XUZHOU (CN); Zhijun LU, XUZHOU (CN)

(21) Appl. No.: 18/444,122

(22) Filed: Feb. 16, 2024

(30) Foreign Application Priority Data
Aug. 24, 2023 (CN) 202311080050.0

(51) Int. Cl. G06Q 10/0631; G06Q 50/04

(52) U.S. Cl. CPC G06Q 10/0631; G06Q 50/04

(57) ABSTRACT

The present disclosure provides an allocating method and device of carbon emission allowance, and a computer-readable storage medium. The allocating method includes: obtaining a maximum value and a minimum value in a first time period of carbon emission intensity values of a plurality of manufacturing entities, wherein the manufacturing entities has at least one process type of the same; determining a relative carbon emission intensity value of each manufacturing entity according to a carbon emission intensity value of each manufacturing entity, the maximum value and the minimum value; and allocating a carbon emission allowance for a second time period after the first time period to each manufacturing entity according to the relative carbon emission intensity value of each manufacturing entity.

### CROSS-REFERENCE TO RELATED APPLICATIONS

The present disclosure is based on and claims priority to China Patent Application No. 202311080050.0 filed on Aug. 24, 2023, the disclosure of which is incorporated by reference herein in its entirety.

### TECHNICAL FIELD

The present disclosure relates to an allocating method and device of carbon emission allowance and a computer-readable storage medium.

### BACKGROUND

Carbon emission refers to greenhouse gas (for example, carbon dioxide) emission. To cope with the global energy crisis and achieve the goal of energy conservation and emission reduction, it is an urgent task to reduce the carbon emission of manufacturing entities.

Carbon emission allowance refers to a greenhouse gas emission reduction quota required to be completed according to the regulations. By allocating the corresponding carbon emission allowance for each manufacturing entity to restrict an upper limit of carbon emission of each manufacturing entity, the carbon emission of manufacturing entities can be effectively reduced.

In the related art, when allocating a carbon emission allowance, the carbon emission allowance of each manufacturing entity in a current time period (for example, this year) is determined according to the carbon emission allowance of each manufacturing entity in a previous time period (for example, last year).

### SUMMARY

According to an aspect of the embodiment of the present disclosure, an allocating method of carbon emission allowance is provided. The allocating method comprises: obtaining a maximum value and a minimum value in a first time period of carbon emission intensity values of a plurality of manufacturing entities, wherein the manufacturing entities has at least one process type of the same; determining a relative carbon emission intensity value of each manufacturing entity according to a carbon emission intensity value of each manufacturing entity, the maximum value and the minimum value; and allocating a carbon emission allowance for a second time period after the first time period to each manufacturing entity according to the relative carbon emission intensity value of each manufacturing entity.

In some embodiments, the allocating a carbon emission allowance for a second time period after the first time period to each manufacturing entity according to the relative carbon emission intensity value of each manufacturing entity comprises: allocating the carbon emission allowance for the second time period to each manufacturing entity according to the relative carbon emission intensity value of each manufacturing entity, a production plan of each manufacturing entity in the second time period and a regulating coefficient, wherein the regulating coefficient is determined based on a change of a carbon emission allowance of the plurality of manufacturing entities in the second time period relative to a carbon emission allowance of the plurality of manufacturing entities in the first time period.

In some embodiments, the carbon emission allowance of each manufacturing entity in the second time period is determined according to a product of the relative carbon emission intensity value of each manufacturing entity, a planned industrial output value of each manufacturing entity in the second time period and the regulating coefficient.

In some embodiments, the relative carbon emission intensity value is negatively correlated with a first difference between the maximum value and the minimum value.

In some embodiments, the relative carbon emission intensity value of each manufacturing entity is positively correlated with a second difference between the carbon emission intensity value of each manufacturing entity and the minimum value, or positively correlated with a third difference between the maximum value and the carbon emission intensity value of each manufacturing entity.

In some embodiments, the relative carbon emission intensity value of each manufacturing entity is determined according to a ratio of one of the second difference and the third difference to the first difference.

In some embodiments, process types of the plurality of manufacturing entities are the same.

In some embodiments, each group of manufacturing entities of a plurality of groups of manufacturing entities comprises the plurality of manufacturing entities, and different groups of manufacturing entities have completely different process types.

In some embodiments, the at least one process type comprises one or more of a blanking process, a molding process, a welding process, a machining process, a surface treatment process, a painting process, an assembly process, a debugging process and a carbon emission reduction technology.

In some embodiments, the plurality of manufacturing entities belongs to a same manufacturing group.

According to another aspect of the embodiment of the present disclosure, an allocating device of carbon emission allowance is provided. The allocating device comprises: a memory; and a processor coupled to the memory. The processor is configured, based on instructions stored in the memory, to obtain a maximum value and a minimum value in a first time period of carbon emission intensity values of a plurality of manufacturing entities, wherein the plurality of manufacturing entities has at least one process type of the same; determine a relative carbon emission intensity value of each manufacturing entity according to a carbon emission intensity value of each manufacturing entity, the maximum value and the minimum value; and allocate a carbon emission allowance for a second time period after the first time period to each manufacturing entity according to the relative carbon emission intensity value of each manufacturing entity.

In some embodiments, the processor is configured to allocate the carbon emission allowance for the second time period to each manufacturing entity according to the relative carbon emission intensity value of each manufacturing entity, a production plan of each manufacturing entity in the second time period and a regulating coefficient, wherein the regulating coefficient is determined based on a change of a carbon emission allowance of the plurality of manufacturing entities in the second time period relative to a carbon emission allowance of the plurality of manufacturing entities in the first time period.

In some embodiments, the carbon emission allowance of each manufacturing entity in the second time period is determined according to a product of the relative carbon emission intensity value of each manufacturing entity, a planned industrial output value of each manufacturing entity in the second time period and the regulating coefficient.

In some embodiments, the relative carbon emission intensity value is negatively correlated with a first difference between the maximum value and the minimum value.

In some embodiments, the relative carbon emission intensity value of each manufacturing entity is positively correlated with a second difference between the carbon emission intensity value of each manufacturing entity and the minimum value, or positively correlated with a third difference between the maximum value and the carbon emission intensity value of each manufacturing entity.

In some embodiments, the relative carbon emission intensity value of each manufacturing entity is determined according to a ratio of one of the second difference and the third difference to the first difference.

In some embodiments, process types of the plurality of manufacturing entities are the same.

In some embodiments, each group of manufacturing entities of a plurality of groups of manufacturing entities comprises the plurality of manufacturing entities, and different groups of manufacturing entities have completely different process types.

In some embodiments, the plurality of manufacturing entities belongs to a same manufacturing group.

According to still another aspect of the embodiment of the present disclosure, a non-transitory computer-readable storage medium is provided. The non-transitory computer-readable storage medium comprises computer program instructions that, when executed by a processor, implement the allocating method according to any of the above-described embodiments.

According to yet another aspect of the embodiment of the present disclosure, a computer program product is provided. The computer program product comprises a computer program that, when executed by a processor, implements the allocating method according to any of the above-described embodiments.

The technical solutions of the present disclosure will be further described in detail below by way of the accompanying drawings and embodiments.

### BRIEF DESCRIPTION OF THE ACCOMPANYING DRAWINGS

To explain the embodiments of the present disclosure or the technical solutions in the related art more explicitly, the accompanying drawings required to be used in the description of the embodiments or the prior art will be briefly introduced below. It is apparent that the accompanying drawings illustrated below are merely some of the embodiments of the present disclosure. For those of ordinary skill in the art, other accompanying drawings may also be obtained according to these accompanying drawings on the premise that no inventive effort is involved.

FIG. 1 is a schematic flowchart of an allocating method of carbon emission allowance according to some embodiments of the present disclosure;

FIG. 2 is a schematic flowchart of an allocating method of carbon emission allowance according to other embodiments of the present disclosure;

FIG. 3 is a schematic structural diagram of an allocating device of carbon emission allowance according to some embodiments of the present disclosure;

FIG. 4 is a schematic structural diagram of an allocating device of carbon emission allowance according to other embodiments of the present disclosure.

### DETAILED DESCRIPTION

The technical solutions in the embodiments of the present disclosure will be explicitly and completely described below in conjunction with the accompanying drawings in the embodiments of the present disclosure. Apparently, the embodiments described are merely a part of, rather than all of the embodiments of the present disclosure. On the basis of the embodiments of the present disclosure, all the other embodiments obtained by those of ordinary skill in the art on the premise that no inventive effort is involved shall fall into the protection scope of the present disclosure.

Unless otherwise specified, the relative arrangements, numerical expressions and numerical values of the components and steps expounded in these embodiments shall not limit the scope of the present disclosure.

At the same time, it should be understood that for ease of description, the dimensions of various parts shown in the accompanying drawings are not drawn according to actual proportional relations.

The techniques, methods, and apparatuses known to those of ordinary skill in the relevant art might not be discussed in detail. However, the techniques, methods, and apparatuses shall be considered as a part of the granted description in appropriate situations.

Among all the examples shown and discussed here, any specific value shall be construed as being merely exemplary, rather than as being restrictive. Thus, other examples of the exemplary embodiments may have different values.

It should be noted that: similar numerals and letters present similar items in the following accompanying drawings, and therefore, once an item is defined in one accompanying drawing, it is unnecessary to make further discussion on it in a subsequent accompanying drawing.

The inventors have noticed that, the allocation of the carbon emission allowance is not reasonable in the related art, which leads to the problem that there is a waste of the carbon emission allowance of a lower-emission manufacturing entity and an apparent shortage of the carbon emission allowance of a higher-emission manufacturing entity, so that the higher-emission manufacturing entity involves a high cost in implementing energy conservation and emission reduction.

To solve the above-described problem, the embodiments of the present disclosure provide the following solutions.

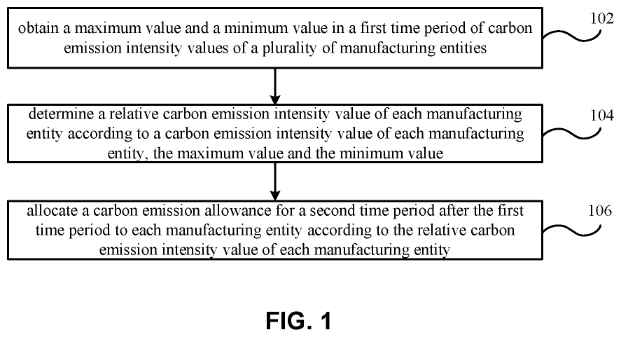

FIG. 1 is a schematic flowchart of an allocating method of carbon emission allowance according to some embodiments of the present disclosure.

In step 102, a maximum value and a minimum value of carbon emission intensity values of a plurality of manufacturing entities in the first time period are obtained.

Here, the plurality of manufacturing entities has at least one process type of the same. That is, the plurality of manufacturing entities is the same type of manufacturing entities with at least one same process type. For example, by using a clustering method to cluster manufacturing entities, the plurality of manufacturing entities of the same type can be obtained.

For example, a plurality of carbon emission intensity values of the plurality of manufacturing entities in the first time period (for example, the previous year, the previous quarter or the previous month, and the like) may be counted, and the maximum value and the minimum value of carbon emission intensity values may be determined from the plurality of carbon emission intensity values.

In step 104, a relative carbon emission intensity value of each manufacturing entity is determined according to a carbon emission intensity value of each manufacturing entity, the maximum value, and the minimum value.

In some embodiments, the carbon emission intensity value of each manufacturing entity may be normalized according to the maximum value and the minimum value of carbon emission intensity values in the first time period of the plurality of manufacturing entities, and the relative carbon emission intensity value of each manufacturing entity may be determined based on normalized result.

It should be understood that, the carbon emission intensity value of each manufacturing entity refers to the carbon emission intensity value in the first time period of each manufacturing entity. The relative carbon emission intensity value of each manufacturing entity reflects a relative relationship in the first time period between the carbon emission intensity value of each manufacturing entity and carbon emission intensity values of other manufacturing entities.

In step 106, a carbon emission allowance for a second time period after the first time period is allocated to each manufacturing entity, according to the relative carbon emission intensity value of each manufacturing entity.

For example, the second time period has the same unit as the first time period. In some embodiments, the second time period may be this year, this quarter or this month, and the like.

In some embodiments, the total amount of carbon emission allowance of the plurality of manufacturing entities in the second time period is fixed after allocation. The carbon emission allowance allocated from the total amount to each manufacturing entity in the second time period may be determined according to the relative carbon emission intensity value of each manufacturing entity.

In some embodiments, according to the relative carbon emission intensity value of each manufacturing entity, the carbon emission allowance for the second time period may be allocated to each manufacturing entity using a carbon emission allocating model.

In the above-described embodiments, for each manufacturing entity of the plurality of manufacturing entities with at least one process type of the same, the relative carbon emission intensity value of each manufacturing entity is determined according to the maximum value and the minimum value of carbon emission intensity values of the plurality of manufacturing entities in the first time period, and the carbon emission intensity value of each manufacturing entity, and then the carbon emission allowance of each manufacturing entity in the second time period after the first time period is determined according to the relative carbon emission intensity value of each manufacturing entity. In this way, since different types of processes produce different carbon emissions, and the plurality of manufacturing entities has at least one process type of the same, the relative carbon emission intensity value of each manufacturing entity reflects the carbon emission intensity value of each manufacturing entity relative to other manufacturing entities of the same type. This method of determining the carbon emission allowance of each manufacturing entity based on the relative carbon emission intensity value of each manufacturing entity takes into account the process differences of different manufacturing entities, which improves the rationality of the carbon emission allowance allocation, thereby reducing the cost involved in implementing energy conservation and emission reduction for a higher-emission manufacturing entity.

In some embodiments, the relative carbon emission intensity value of each manufacturing entity is negatively correlated with a first difference between the maximum value and the minimum value of carbon emission intensity values of the plurality of manufacturing entities in the first time period.

Manufacturing entities with different production process characteristics each has a corresponding variation range of carbon emission intensity value (that is, a limit range of carbon emission intensity value), and the first difference between the maximum value and the minimum value of carbon emission intensity values of the plurality of manufacturing entities in the first time period can indicate a variation range of the carbon emission intensity value of one type of manufacturing entities with at least one same process type in the first time period. In this way, the negative correlation between the relative carbon emission intensity value of each manufacturing entity and the first difference indicates a relationship between the carbon emission intensity value of each manufacturing entity in the first time period and the variation range of the carbon emission intensity value of the same type of manufacturing entities, so that the process characteristics of the same type of manufacturing entities are more adequately considered during the process of determining the carbon emission allowance, which is helpful to further improve the rationality of the carbon emission allowance allocation, thereby reducing the cost involved in implementing energy conservation and emission reduction for a higher-emission manufacturing entity.

In some embodiments, the relative carbon emission intensity value of each manufacturing entity is positively correlated with a second difference between the carbon emission intensity value of each manufacturing entity and the minimum value. For example, the relative carbon emission intensity value of each manufacturing entity is positively correlated with the second difference between the carbon emission intensity value of each manufacturing entity and the minimum value, and negatively correlated with the first difference between the maximum value and the minimum value of carbon emission intensity values of the plurality of manufacturing entities in the first time period.

In other embodiments, the relative carbon emission intensity value of each manufacturing entity is positively correlated with a third difference between the maximum value and the carbon emission intensity value of each manufacturing entity. For example, the relative carbon emission intensity value of each manufacturing entity is positively correlated with the third difference between the maximum value and the carbon emission intensity value of each manufacturing entity, and negatively correlated with the first difference between the maximum value and the minimum value of the carbon emission intensity values of the plurality of manufacturing entities in the first time period.

In some embodiments, the relative carbon emission intensity value of each manufacturing entity is determined according to a ratio of one of the second difference and the third difference to the first difference. For example, the relative carbon emission intensity value of each manufacturing entity i is Iir, Iir=(Ii−Imin)/(Imax−Imin) or Iir=(Imax−Ii)/(Imax−Imin), where Ii represents the carbon emission intensity value of the manufacturing entity i in the first time period, Imax represents the maximum value of carbon emission intensity values of the plurality of manufacturing entities comprising the manufacturing entity i in the first time period, and Imin represents the minimum value of carbon emission intensity values of the plurality of manufacturing entities comprising the manufacturing entity i in the first time period.

In this way, the relative carbon emission intensity value of each manufacturing entity can reflect a relative position of the carbon emission intensity value of each manufacturing entity in the first time period in the variation range of the carbon emission intensity value of the same type of manufacturing entities to which each manufacturing entity belongs. This method of determining the carbon emission allowance of each manufacturing entity based on the relative carbon emission intensity value of each manufacturing entity can reflect the process differences of different manufacturing entities in the same type of manufacturing entities more accurately. The rationality of the subsequent carbon emission allowance allocation is further improved, and the cost involved in implementing energy conservation and emission reduction for a higher-emission manufacturing entity is further reduced.

In some embodiments, the carbon emission allowance of each manufacturing entity in the second time period after the first time period may be determined using a historical intensity decline method, in which the relative carbon emission intensity value of each manufacturing entity may be taken as a historical reference value.

It is to be noted that, the determining method of carbon emission allowance mainly comprises a historical emission method, a historical intensity decline method, an industry benchmark method, an entropy method and the like. The historical emission method is suitable for a manufacturing entity with a relatively stable production. However, in the historical emission method, the carbon emission allowance is determined based on the historical carbon emission data of the manufacturing entity, which leads to a larger carbon emission allowance of a higher-emission manufacturing entity all the time. The carbon emission of the higher-emission manufacturing entity cannot be effectively controlled, and the energy conservation and emission reduction cannot be achieved effectively. In the industry benchmark method, sufficient collection of historical carbon emission data of various manufacturing entities of the same industry is required to determine an industry carbon emission benchmark, which results in difficulty for implementing and low feasibility. In the entropy method, specific factors (for example, a carbon emission intensity value, a total amount of historical carbon emission, a total amount and intensity of energy consumption, and the like of the manufacturing entity) that affect the carbon emission of a manufacturing entity need to be determined, which also results in difficulty for implementing. In the historical intensity decline method, the historical benchmark value is determined based on the intensity data of historical carbon emission, and a current carbon emission allowance is determined according to the historical benchmark value, a current production plan and a regulating coefficient. Compared with other methods, using the historical intensity decline method to determine the carbon emission allowance is not only simpler to calculate but also easier to implement.

However, the inventors have noticed that, simply using the carbon emission intensity values of manufacturing entities over a past period of time as historical reference values and determining carbon emission allowance based on the historical intensity decline method will result in that carbon emission allowances for both a lower-emission manufacturing entity and a higher-emission manufacturing entity are determined by using the same regulating coefficient based on respective historical carbon emission intensity values.

This unreasonable determining method of carbon emission allowance will greatly increase the production line transformation cost to achieve energy conservation and emission reduction for a higher-emission manufacturing entity, thereby affecting the production management activities of a higher-emission manufacturing entity.

In view of this, the embodiments of the present disclosure provide the following solutions.

In some embodiments, in step 106, the carbon emission allowance for the second time period may be allocated to each manufacturing entity, according to the relative carbon emission intensity value, a production plan of each manufacturing entity in the second time period and a regulating coefficient.

Here, the regulating coefficient may be determined based on a change of a carbon emission allowance of the plurality of manufacturing entities in the second time period relative to a carbon emission allowance of the plurality of manufacturing entities in the first time period. For example, the regulating coefficient may be a ratio of the difference between the carbon emission allowance of the plurality of manufacturing entities in the second time period (for example, this year) and the carbon emission allowance in the first time period (for example, last year) of the plurality of manufacturing entities to the carbon emission allowance of the plurality of manufacturing entities in the first time period (for example, last year).

In the above embodiments, the carbon emission allowance of each manufacturing entity is determined by using the relative carbon emission intensity value of each manufacturing entity as the historical reference value, instead of directly using a respective actual carbon emission intensity value in the past time period (that is, the first time period) as the historical reference value. In this way, the process characteristics of each manufacturing entity are adequately considered in determining the carbon emission allowance of each manufacturing entity, which improves the rationality of the carbon emission allowance allocation, thereby reducing the cost involved in implementing energy conservation and emission reduction for a higher-emission manufacturing entity.

In some embodiments, the production plan of each manufacturing entity in the second time period may be presented by a planned yield or a planned output value of each manufacturing entity in the second time period.

In some embodiments, the carbon emission allowance of each manufacturing entity in the second time period may be determined according to a product of the relative carbon emission intensity value of each manufacturing entity, a planned industrial output value of each manufacturing entity in the second time period and the regulating coefficient. For example, the carbon emission allowance of each manufacturing entity i in the second time period t is expressed as Cit=Iir×Qit×ft, where Iir represents the relative carbon emission intensity value of the manufacturing entity i, Qit represents the planned industrial output value of the manufacturing entity in the second time period t, and ft represents the regulating coefficient.

In these embodiments, if the relative carbon emission intensity value of each manufacturing entity is determined by using the ratio of one of the second difference and the third difference to the first difference, formula Iir=(Ii−Imin)/(Imax−Imin) is substituted into formula Cit=Iir×Qit×ft to obtain formula Cit=(Ii−Imin)/(Imax−Imin)×Qit×ft=Ii×Qit×ft×[(1−Imin/li)/(Imax−Imin)]=Ii×Qit×ftr, where ftr=ft×[(1−Imin/Ii)/(Imax−Imin)] is a relative regulating coefficient of each manufacturing entity i.

It can be seen that, the relative regulating coefficient ftr corresponding to each manufacturing entity may be determined according to the relative carbon emission intensity of each manufacturing entity i and the regulating coefficient. The relative regulating coefficient ftr can reflect the process differences of different manufacturing entities i. That is, in the method of determining the carbon emission allowance of each manufacturing entity i in the second time period by using the product of the relative carbon emission intensity value Iir of each manufacturing entity, the planned industrial output value Qit of each manufacturing entity in the second time period and the regulating coefficient ft, it is substantively to determine the carbon emission allowance using different regulating coefficients for different manufacturing entities based on the carbon emission intensity value of each manufacturing entity i in the past time period as the historical reference value, so that the carbon emission allowances for both lower-emission and higher-emission manufacturing entities may be determined according to respective corresponding regulating coefficient (i.e., a relative regulating coefficient ftr). Compared with the method of determining all the carbon emission allowances according to the same regulating coefficient, the rationality of the carbon emission allowance allocation is improved, thereby reducing the cost involved in implementing energy conservation and emission reduction for a higher-emission manufacturing entity.

In some embodiments, the process types may comprise one or more of a blanking process, a molding process, a welding process, a machining process, a surface treatment process, a painting process, an assembly process, a debugging process and a carbon emission reduction technology. For example, the blanking process comprises sub-processes such as laser cutting, plasma cutting, numerical control flame cutting or saw machine cutting. The molding process comprises sub-processes such as free forging, die forging, precision forging, die casting, hot extrusion, punching, cold extrusion, cold heading, cold drawing, wire drawing or cold rolling. The surface treatment process comprises sub-processes such as shot peening, electroplating, electrophoresis, sand blasting, polishing, micro-arc oxidation, electric arc spraying, laser spraying or ultra-high speed laser cladding. The carbon emission reduction technology comprises technologies such as wind power generation, solar photovoltaic power generation, geothermal power generation or short-process thermal treatment.

For example, if the processes used by a manufacturing entity A comprise laser cutting, die casting and punching, the processes used by a manufacturing entity B comprise numerical control flame cutting, precision forging and wind power generation technology, and the processes used by a manufacturing entity C comprise saw machine cutting, precision forging, polishing and solar photovoltaic power generation technology, the manufacturing entity A has process types comprising the blanking process and the molding process, the manufacturing entity B has process types comprising the blanking process, the molding process and the carbon emission reduction technology; and the manufacturing entity C has process types comprising the blanking process, the molding process, the surface treatment process and the carbon emission reduction technology. Therefore, the manufacturing entity A, the manufacturing entity B and the manufacturing entity C have the same two process types, and the manufacturing entity A, the manufacturing entity B and the manufacturing entity C may be determined as the same type of manufacturing entity.

In this way, manufacturing entities are classified by using the carbon emission reduction technology as a process type, which can avoid the unfair problem that the carbon emission allowance is still determined according to the same regulating coefficient for a higher-emission entity which has implemented more carbon emission reduction technologies, thereby further improving the rationality of carbon emission allocation and further reducing the cost involved in implementing energy conservation and emission reduction for a higher-emission manufacturing entity.

In some embodiments, the plurality of manufacturing entities may belong to the same manufacturing group. For example, the plurality of manufacturing entities may be a plurality of subsidiaries or branches belonging to the same manufacturing group. For example, the manufacturing process of each subsidiary of the same manufacturing group may be investigated in advance to establish a process summary list of each subsidiary. Then, according to the process type of each subsidiary, the subsidiaries belonging to the same manufacturing group may be divided into a plurality of groups of companies, each group of which comprising a plurality of subsidiaries with at least one process type of the same. Thereafter, the carbon emission allowance of each subsidiary in each group of companies may be determined according to the method shown in FIG. 1. In this way, the total carbon emission allowance of the same manufacturing group may be allocated to various manufacturing entities more reasonably, which is helpful to reduce the cost involved in implementing energy conservation and emission reduction for some higher-emission manufacturing entities in the same manufacturing group and alleviate the unfair problem resulting from the allocation of carbon emission allowance within the same manufacturing group.

In some embodiments, process types of the plurality of manufacturing entities are the same, that is, the plurality of manufacturing entities has identical process types. For example, a plurality of manufacturing entities with identical process types in the same manufacturing group may be determined as one type of manufacturing entities.

Each process type of different manufacturing entities in the same type of manufacturing entities has relatively close proportion in the energy consumption of different manufacturing entities, and different manufacturing entities in the same type of manufacturing entities also have relatively close carbon emission levels. Thus, by classifying manufacturing entities in this way, the relative carbon emission intensity value of each manufacturing entity determined subsequently can more accurately reflect the carbon emission level resulting from the process characteristics of each manufacturing entity, which is helpful to further improve the rationality of the carbon emission allowance allocation and further reduce the cost involved in implementing energy conservation and emission reduction for a higher-emission manufacturing entity.

In some embodiments, each group of manufacturing entities of the plurality of groups of manufacturing entities comprises the plurality of manufacturing entities with at least one process type of the same, and different groups of manufacturing entities have completely different process types. For example, the manufacturing entities of the same manufacturing group may be divided into a plurality of groups of manufacturing entities according to the process types, wherein the process types of different groups of manufacturing entities are completely different.

In these embodiments, the step 102 may comprise obtaining a maximum value and a minimum value in the first time period of carbon emission intensity values of a plurality of manufacturing entities in each group of manufacturing entities. The step 104 may comprise determining a relative carbon emission intensity value of each manufacturing entity in each group of manufacturing entities according to a carbon emission intensity value of each manufacturing entity in each group of manufacturing entities, the maximum value and the minimum value. The step 106 may comprise allocating a carbon emission allowance for the second time period to each manufacturing entity in each group of manufacturing entities according to the relative carbon emission intensity value of each manufacturing entity in each group of manufacturing entities.

In this way, for the plurality of groups of manufacturing entities with completely different process types, the allocated carbon emission allowance for each manufacturing entity in each group of manufacturing entities may be determined according to the aforementioned method, thereby further improving the rationality of the carbon emission allowance allocation for the plurality of groups of manufacturing entities with completely different process types, and further reducing the cost involved in implementing energy conservation and emission reduction for a higher-emission manufacturing entity.

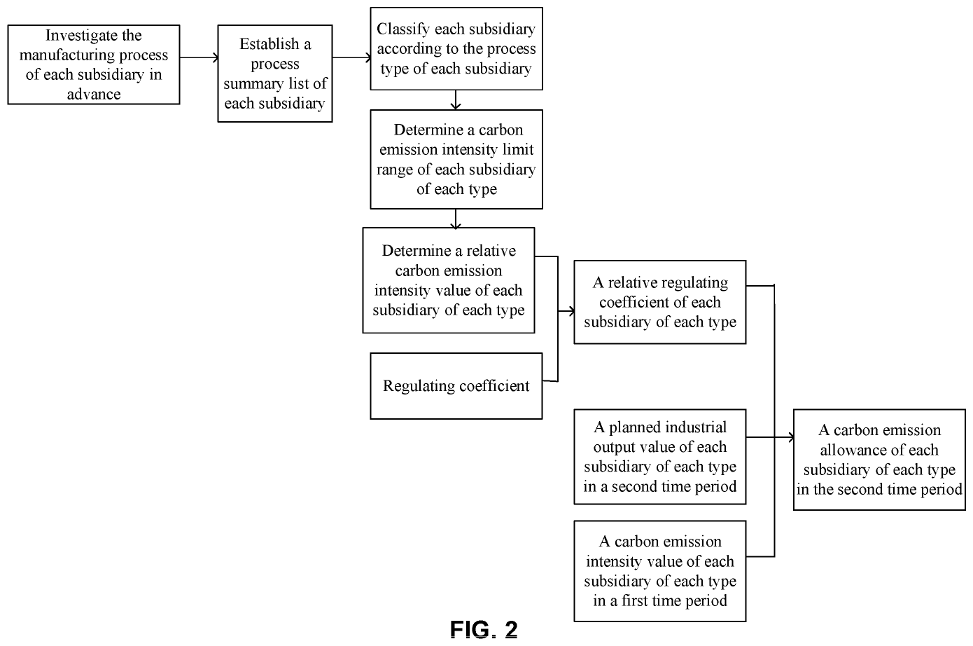

FIG. 2 is a schematic flowchart of an allocating method of carbon emission allowance according to other embodiments of the present disclosure. In the embodiments shown in FIG. 2, description will be made by taking a manufacturing entity as a subsidiary as an example.

As shown in FIG. 2, for each subsidiary of the same manufacturing group, the manufacturing process of each subsidiary may be investigated in advance to establish the process summary list of each subsidiary. Then, each subsidiary may be classified to a type of subsidiaries according to the process type of each subsidiary, and each type of subsidiaries comprise a plurality of subsidiaries with at least one process type of the same. Thereafter, the carbon emission intensity variation range of each type of plurality of subsidiaries may be determined according to a first difference between the maximum value and the minimum value of carbon emission intensity values of each type of plurality of subsidiaries in the first time period.

For each subsidiary of each type, the relative carbon emission intensity value of this subsidiary is determined according to a ratio of a second difference between the carbon emission intensity value of this subsidiary in the first time period and the minimum value of carbon emission intensity values of the plurality of subsidiaries of this type to the first difference; or the relative carbon emission intensity value of this subsidiary is determined according to a ratio of a third difference between the maximum value of carbon emission intensity values of the plurality of subsidiaries of this type and the carbon emission intensity value of this subsidiary in the first time period to the first difference.

The relative regulating coefficient corresponding to each subsidiary of each type may be determined according to the regulating coefficient and the relative carbon emission intensity value of each subsidiary of each type. Furthermore, the carbon emission allowance of each subsidiary of each type in the second time period is determined according to the planned industrial output value of this subsidiary in the second time period, the carbon emission intensity value of this subsidiary in the first time period and the relative regulating coefficient corresponding to this subsidiary.

The production process chains, process types and energy structures of various subsidiaries of the same manufacturing group are different, and the carbon emission levels corresponding to various subsidiaries are also different. For example, subsidiaries with long production process chain mainly have a large number of processes such as machining process, surface treatment process, thermal treatment process or molding process, and these subsidiaries have a relatively high energy consumption per unit product output (that is, a relatively high energy proportion), as well as a relatively high carbon emission intensity value. However, subsidiaries with short production process chain mainly have processes such as blanking process, welding process, assembly process or debugging process, and these subsidiaries have a relatively low energy consumption per unit product output (that is, a relatively low energy proportion), as well as a relatively low carbon emission intensity value. For manufacturing subsidiaries with different production processes and energy structures, the variation ranges corresponding to the carbon emission intensity values are different. If the carbon emission allowance is still allocated by using the conventional historical intensity reduction method, the production line transformation cost of some manufacturing subsidiaries with higher carbon emission intensity will be greatly increased, which will seriously hinder the production management activities of the subsidiaries.

By counting the manufacturing process of each subsidiary in the same manufacturing group, and classifying each subsidiary according to the process type (for example, subsidiaries with a large number of relatively high energy consumption processes such as machining process, surface treatment process, thermal treatment process or molding process are classified into one type of subsidiaries, and subsidiaries with relatively low energy consumption processes such as blanking process, welding process, assembly process or debugging process are classified into another type of subsidiaries), the variation range of the carbon emission intensity value corresponding to each subsidiary is determined. After that, based on the variation range of the carbon emission intensity value corresponding to each subsidiary, the relative carbon emission intensity of each subsidiary is determined, and then the relative regulating coefficient corresponding to each subsidiary is obtained. Thereafter, the carbon emission allowance of each subsidiary is determined according to the relative regulating coefficient corresponding to each subsidiary. In this way, the influence of the manufacturing process differences on the fairness and rationality of the carbon emission allowance allocation of each subsidiary is adequately considered, which effectively improves the fairness and rationality of the carbon emission allowance allocation, thereby effectively reducing the cost involved in implementing energy conservation and emission reduction for a higher-emission manufacturing entity.

For other descriptions of the method shown in FIG. 2, reference may be made to the description of the related embodiment in FIG. 1 described previously, which will not be described in detail here.

Various embodiments in this specification are described in a progressive manner, and differences from other embodiments are mainly illustrated in each embodiment. The same or similar parts between various embodiments can be referred to each other. As for the embodiments of a device, since they substantially correspond to the embodiments of a method, the descriptions are relatively simple. For relevant parts, reference may be made to the descriptions of the embodiments of a method.

In some embodiments of the present disclosure, an allocating device of carbon emission allowance is also provided. The allocating device comprises module(s) for performing the method of any of the above-described embodiments.

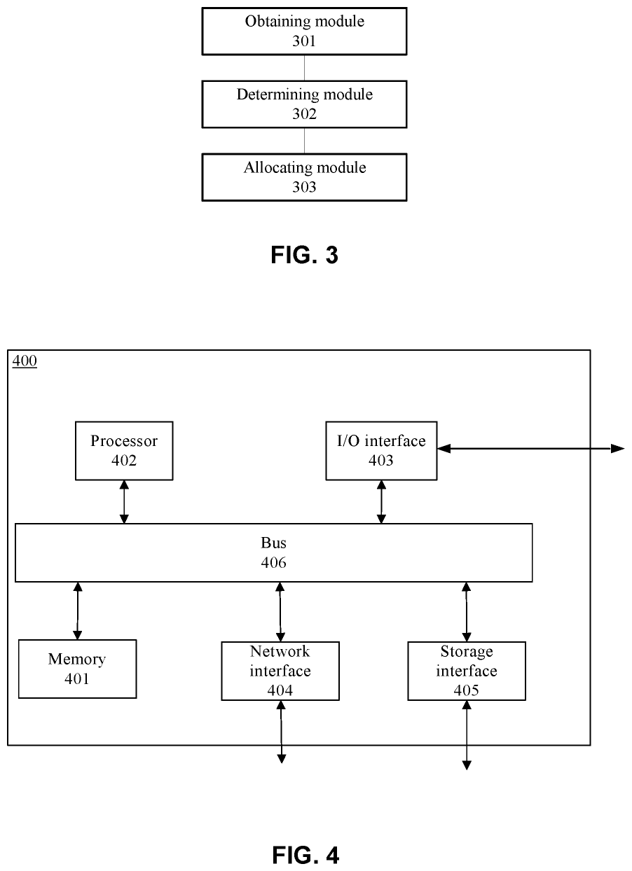

FIG. 3 is a schematic structural view of an allocating device of carbon emission allowance according to some embodiments of the present disclosure.

As shown in FIG. 3, the allocating device of carbon emission allowance comprises an obtaining module 301, a determining module 302 and an allocating module 303.

The obtaining module 301 may be configured to obtain a maximum value and a minimum value in the first time period of the carbon emission intensity values of a plurality of manufacturing entities. The plurality of manufacturing entities has at least one process type of the same.

The determining module 302 may be configured to determine a relative carbon emission intensity value of each manufacturing entity according to a carbon emission intensity value of each manufacturing entity, the maximum value and the minimum value.

The allocating module 303 may be configured to allocate a carbon emission allowance for a second time period after the first time period to each manufacturing entity according to the relative carbon emission intensity value of each manufacturing entity.

In some embodiments, the allocating module 303 may also be configured to allocate the carbon emission allowance for the second time period to each manufacturing entity according to the relative carbon emission intensity value of each manufacturing entity, a production plan of each manufacturing entity in the second time period and a regulating coefficient, wherein the regulating coefficient is determined based on the change of a carbon emission allowance of the plurality of manufacturing entities in the second time period relative to a carbon emission allowance of the plurality of manufacturing entities in the first time period.

In some embodiments, the allocating module 303 may also be configured to allocate the carbon emission allowance for the second time period to each manufacturing entity according to a product of the relative carbon emission intensity value of each manufacturing entity, a planned industrial output value of each manufacturing entity in the second time period and the regulating coefficient.

In some embodiments, the relative carbon emission intensity value of each manufacturing entity is negatively correlated with a first difference between the maximum value and the minimum value.

In some embodiments, the relative carbon emission intensity value of each manufacturing entity is positively correlated with a second difference between the carbon emission intensity value of each manufacturing entity and the minimum value, or positively correlated with a third difference between the maximum value and the carbon emission intensity value of each manufacturing entity.

In some embodiments, the relative carbon emission intensity value of each manufacturing entity is determined according to the ratio of one of the second difference and the third difference to the first difference.

In some embodiments, process types of the plurality of manufacturing entities are the same.

In some embodiments, each group of manufacturing entities of a plurality of groups of manufacturing entities comprises the plurality of manufacturing entities, and different groups of manufacturing entities have completely different process types.

In some embodiments, the plurality of manufacturing entities belongs to a same manufacturing group.

In some embodiments, the allocating device of carbon emission allowance may further comprise other modules for performing other operations according to any of the above-described embodiments.

FIG. 4 is a schematic structural view of an allocating device of carbon emission allowance according to other embodiments of the present disclosure.

As shown in FIG. 4, the allocating device of carbon emission allowance 400 comprises a memory 401 and a processor 402 coupled to the memory 401. The processor 402 is configured to perform the allocating method according to any of the aforementioned embodiments based on instructions stored in the memory 401.

The memory 401 may comprise, for example, a system memory, a fixed non-volatile storage medium, and the like. The system memory may store, for example, an operation system, an application program, a boot loader, and other programs.

The allocating device of carbon emission allowance 400 may further comprise an I/O interface 403, a network interface 404, a storage interface 405, and the like. These interfaces 403, 404, and 405 may be connected, for example, via a bus 406 via which the memory 401 and the processor 402 may be connected. The I/O interface 403 provides a connection interface for input/output devices such as a display, a mouse, a keyboard, a touch screen and the like. The network interface 404 provides a connection interface for various networking devices. The storage interface 405 provides a connection interface for an external storage device such as an SD card, a USB flash disk and the like.

The embodiments of the present disclosure further provide a non-transitory computer-readable storage medium comprising computer program instructions, wherein the method according to any one of the above-described embodiments is implemented when the computer program instructions are executed by a processor.

The embodiments of the present disclosure also provide a computer program product comprising a computer program, wherein the method according to any one of the above-described embodiments is implemented when the computer program is executed by a processor.

Hereto, various embodiments of the present disclosure have been described in detail. Some details well known in the art are not described to avoid obscuring the concept of the present disclosure. According to the above description, those skilled in the art would fully understand how to implement the technical solutions disclosed here.

Various embodiments in this specification are described in a progressive manner, and each embodiment focuses on description of difference from other embodiments. For the same or similar parts between various embodiments, reference may be made to each other. As for the embodiments of the device and the vehicle, since they substantially correspond to the embodiments of the method, the descriptions are relatively simple. For the relevant parts, reference may be made to the description of the embodiments of the method.

Those skilled in the art should understand that the embodiments of the present disclosure may be provided as a method, a system, or a computer program product. Accordingly, the present disclosure may take the form of an entirely hardware embodiment, an entirely software embodiment, or a combination of software and hardware aspects. Moreover, the present disclosure may take the form of a computer program product implemented on one or more computer-usable non-transitory storage media (comprising but not limited to a disk memory, a CD-ROM, an optical memory, and the like) with computer usable program codes thereon.

The present disclosure is described with reference to the flowcharts and/or block diagrams of methods, devices (systems), and computer program products according to the embodiments of the present disclosure. It should be understood that a function specified in one or more processes in the flowcharts and/or one or more blocks in the block diagrams may be implemented by computer program instructions. These computer program instructions may be provided to a processor of a general purpose computer, a special purpose computer, an embedded processing machine, or other programmable data processing devices to produce a machine, such that a device for implementing a function specified in one or more processes of flowcharts and/or one or more blocks in block diagrams is produced by the instructions executed by a processor of a computer or other programmable data processing devices.

These computer program instructions may also be stored in a computer readable memory that can guide a computer or other programmable data processing devices to operate in a particular manner, such that the instructions stored in the computer readable memory produce an article of manufacture comprising an instruction device. The instruction device implements a function specified in one or more processes in flow charts or one or more blocks in block diagrams.

These computer program instructions may also be loaded onto a computer or other programmable data processing devices to perform a series of operational steps on the computer or other programmable devices to produce a computer-implemented process, such that the instructions executed on the computer or other programmable devices provide steps for implementing a function specified in one or more processes of the flowcharts and/or one or more blocks in the block diagrams.

Although some specific embodiments of the present disclosure have been described in detail by way of examples, those skilled in the art should understand that the above examples are only for the purpose of illustration but not for limiting the scope of the present disclosure. It should be understood by those skilled in the art that modifications to the above embodiments and equivalently substitution of a part of the technical features can be made without departing from the scope and spirit of the present disclosure. The scope of the present disclosure is defined by the appended claims.

What is claimed is:

1. An allocating method of carbon emission allowance, comprising:
obtaining a maximum value and a minimum value in a first time period of carbon emission intensity values of a plurality of manufacturing entities, wherein the plurality of manufacturing entities has at least one process type of the same;
determining a relative carbon emission intensity value of each manufacturing entity according to a carbon emission intensity value of each manufacturing entity, the maximum value and the minimum value; and
allocating a carbon emission allowance for a second time period after the first time period to each manufacturing entity according to the relative carbon emission intensity value of each manufacturing entity.

2. The allocating method according to claim 1, wherein the allocating a carbon emission allowance for a second time period after the first time period to each manufacturing entity according to the relative carbon emission intensity value of each manufacturing entity comprises:
allocating the carbon emission allowance for the second time period to each manufacturing entity according to the relative carbon emission intensity value of each manufacturing entity, a production plan of each manufacturing entity in the second time period and a regulating coefficient, wherein the regulating coefficient is determined based on a change of a carbon emission allowance of the plurality of manufacturing entities in the second time period relative to a carbon emission allowance of the plurality of manufacturing entities in the first time period.

3. The allocating method according to claim 2, wherein the carbon emission allowance of each manufacturing entity in the second time period is determined according to a product of the relative carbon emission intensity value of each manufacturing entity, a planned industrial output value of each manufacturing entity in the second time period and the regulating coefficient.

4. The allocating method according to claim 1, wherein the relative carbon emission intensity value is negatively correlated with a first difference between the maximum value and the minimum value.

5. The allocating method according to claim 4, wherein the relative carbon emission intensity value of each manufacturing entity is positively correlated with a second difference between the carbon emission intensity value of each manufacturing entity and the minimum value, or positively correlated with a third difference between the maximum value and the carbon emission intensity value of each manufacturing entity.

6. The allocating method according to claim 5, wherein the relative carbon emission intensity value of each manufacturing entity is determined according to a ratio of one of the second difference and the third difference to the first difference.

7. The allocating method according to claim 1, wherein process types of the plurality of manufacturing entities are the same.

8. The allocating method according to claim 1, wherein each group of manufacturing entities of a plurality of groups of manufacturing entities comprises the plurality of manufacturing entities, and different groups of manufacturing entities have completely different process types.

9. The allocating method according to claim 1, wherein the at least one process type comprises one or more of a blanking process, a molding process, a welding process, a machining process, a surface treatment process, a painting process, an assembly process, a debugging process and a carbon emission reduction technology.

10. The allocating method according to claim 1, wherein the plurality of manufacturing entities belongs to a same manufacturing group.

11. An allocating device of carbon emission allowance, comprising:
a memory; and
a processor coupled to the memory and configured, based on instructions stored in the memory, to:
obtain a maximum value and a minimum value in a first time period of carbon emission intensity values of a plurality of manufacturing entities, wherein the plurality of manufacturing entities has at least one process type of the same;
determine a relative carbon emission intensity value of each manufacturing entity according to a carbon emission intensity value of each manufacturing entity, the maximum value and the minimum value; and
allocate a carbon emission allowance for a second time period after the first time period to each manufacturing entity according to the relative carbon emission intensity value of each manufacturing entity.

12. The allocating device according to claim 11, wherein the processor is configured to:
allocate the carbon emission allowance for the second time period to each manufacturing entity according to the relative carbon emission intensity value of each manufacturing entity, a production plan of each manufacturing entity in the second time period and a regulating coefficient, wherein the regulating coefficient is determined based on a change of a carbon emission allowance of the plurality of manufacturing entities in the second time period relative to a carbon emission allowance of the plurality of manufacturing entities in the first time period.

13. The allocating device according to claim 12, wherein the carbon emission allowance of each manufacturing entity in the second time period is determined according to a product of the relative carbon emission intensity value of each manufacturing entity, a planned industrial output value of each manufacturing entity in the second time period and the regulating coefficient.

14. The allocating device according to claim 11, wherein the relative carbon emission intensity value is negatively correlated with a first difference between the maximum value and the minimum value.

15. The allocating device according to claim 14, wherein the relative carbon emission intensity value of each manufacturing entity is positively correlated with a second difference between the carbon emission intensity value of each manufacturing entity and the minimum value, or positively correlated with a third difference between the maximum value and the carbon emission intensity value of each manufacturing entity.

16. The allocating device according to claim 15, wherein the relative carbon emission intensity value of each manufacturing entity is determined according to a ratio of one of the second difference and the third difference to the first difference.

17. The allocating device according to claim 11, wherein process types of the plurality of manufacturing entities are the same.

18. The allocating device according to claim 11, wherein each group of manufacturing entities of a plurality of groups of manufacturing entities comprises the plurality of manufacturing entities, and different groups of manufacturing entities have completely different process types.

19. The allocating device according to claim 11, wherein the plurality of manufacturing entities belongs to a same manufacturing group.

20. A non-transitory computer-readable storage medium, comprising computer program instructions that, when executed by a processor, implement the allocating method according to claim 1.
